(19) United States
(12) Patent Application Publication
(10) Pub. No.: US 2015/0127495 A1
(43) Pub. Date: May 7, 2015

(54) METHOD, SYSTEM AND COMPUTER PROGRAM FOR MONETIZING DIGITAL OR VIRTUAL CURRENCY

(71) Applicant: Cyril Houri, Miami Beach, FL (US)

(72) Inventor: Cyril Houri, Miami Beach, FL (US)

(21) Appl. No.: 14/155,846

(22) Filed: Jan. 15, 2014

Related U.S. Application Data
(60) Provisional application No. 61/898,727, filed on Nov. 1, 2013.

(51) Int. Cl. G06Q 20/06; G06Q 30/06

(52) U.S. Cl. CPC G06Q 20/06; G06Q 30/0635
USPC 705/26.81

(57) ABSTRACT

Method for a first person to receive a wanted item purchased by a second person in exchange for virtual currency includes generating an order for a wanted item by the first person, assigning an amount of virtual currency to be provided in exchange for fulfillment of the order, displaying an indication of the amount of virtual currency to be provided in exchange for order fulfillment, and enabling the second person to view the indication of the amount of virtual currency to be provided in exchange for order fulfillment and indicate a desire to fulfill the order. The second person can fulfill the order and pay real money for each item to a third party, and the amount of virtual currency to be provided in exchange for fulfillment of the order is forwarded (e.g., released from an escrow account) to the second person upon or after shipping confirmation of the item.

### CROSS-REFERENCE TO RELATED APPLICATION

This application claims priority under 35 U.S.C. §119(e) of U.S. provisional patent application Ser. No. 61/898,727 filed Nov. 1, 2013, which is incorporated by reference herein.

### FIELD OF THE INVENTION

The present invention relates generally to a method, system and computer program that enable purchase of an item using digital or virtual currency, and is particularly useful when merchant or other vendor providing the item does not accept virtual currency.

The present invention therefore relates more specifically to a method, system and computer program that enable one person possessing digital or virtual currency to receive an item they want from a merchant that does not accept digital or virtual currency, paid for by another person that desires digital or virtual currency, with this another person paying the merchant in fiat or real money.

### BACKGROUND OF THE INVENTION

Digital or virtual currency, often used on the Internet, is considered as an alternative to government-backed currency, government-endorsed currency or national currency. For example, bitcoins are a form of Internet currency. Bitcoins are intangible virtual coins in the form of a file that may be stored on a computer or a computer-related device. Specifically, a bitcoin is a unit of digital currency of a peer-to-peer system that is not regulated by any central or governmental authority. Rather, the regulation of bitcoins (i.e., the issuance of new bitcoins and the tracking of transactions involving bitcoins) may be accomplished collectively by the network of people and businesses that conduct business with bitcoins.

However, acceptance of digital or virtual currency (hereinafter referred to simply as virtual currency), whether bitcoins or another form of virtual currency, is not universal and a large number of merchants do not accept virtual currency as payment.

A person that has virtual currency and wants an item from a merchant that is not willing to accept the virtual currency is therefore faced with a dilemma because they cannot monetize their virtual currency.

### SUMMARY OF THE INVENTION

The present invention enables monetization of virtual currency, i.e., an owner of virtual currency to receive an item or service they want through involvement of another person that wants virtual currency. The present invention therefore provides a unique solution to the problem of one person having virtual currency and wanting an item from a merchant that is not willing to accept the virtual currency. This solution generally involves another person that wants virtual currency and is willing to pay real money to the merchant to deliver the item to the first person.

A first embodiment of a method in accordance with the invention for a first person to receive a wanted item purchased by a second person in exchange for virtual currency includes generating, using a first computing device, an order for at least one wanted item by the first person while requiring the first person to assign or allocate an amount of virtual currency for the wanted item (with the virtual currency preferably being placed in escrow to evidence its assignment or allocation), displaying on a second computing device, an indication of the amount of virtual currency to be provided in exchange for fulfillment of the order for the first person, and enabling, using a user interface of the second computing device, the second person to view the indication of the amount of virtual currency to be provided in exchange for fulfillment of the order for the first person and indicate a desire to fulfill the order. Finally, using the second computing device, the second person can fulfill the order and pay real money for each item in the order to a third party, and the amount of virtual currency to be provided in exchange for fulfillment of the order is forwarded (e.g., released from an escrow account) to the second person upon or after shipping confirmation or delivery of each item in the order to the first person. For the purposes herein, “real money” may be considered government-backed currency or currency that is recognized as legal tender by one or more governments or other financial authorities, such as U.S. dollars, Euros, Yen, British Pounds, and payment of real money may be effected using any known payment technique, including credit cards, debit cards, PAYPAL™, and other payment services. Real money thus may be considered money declared by a government or governmental entity to be legal tender. Alternatively, real money may be considered anything other than digital or virtual currency.

Another method in accordance with the invention includes generating, using computing devices, a plurality of orders each for at least one wanted item by a person while requiring the person to assign or allocate an amount of virtual for the wanted item preferably in an escrow account, displaying, on computing devices, a list of orders and an indication of the amount of virtual currency to be provided in exchange for fulfillment of each order, and enabling, using a user interface of the computing devices on which the list of orders is displayed, entry of an indication by another person to fulfill a selected one of the orders and authorize payment of real money for each item in the selected order to a third party. Finally, the amount of virtual currency to be provided in exchange for fulfillment of the selected order is forwarded to the other person upon or after shipping confirmation or delivery of each item in the selected order.

A computer program embodied in non-transitory computer-readable medium on for example, a server, cooperates with other computing devices and vendors' servers to enable, using a first computing device, generation of an order for at least one wanted item and an associated indication of an amount of virtual currency to be provided in exchange for fulfillment of the order, process assignment or allocation of that amount of virtual currency into an escrow account, direct display on a second computing device of the indication of the amount of virtual currency to be provided in exchange for fulfillment of the order and enable, using a user interface of the second computing device, entry of an indication of a desire to fulfill the order and authorization of payment of real money for each item in the order to a third party. The server then forwards (i.e., releases from an escrow account) the amount of virtual currency to be provided in exchange for fulfillment of the order to the payment authorizer upon or after shipping confirmation or delivery of each item in the order.

Another embodiment of a computer program embodied in non-transitory computer-readable medium that may be resident on a central server is configured to enable a plurality of orders to be generated, each for at least one wanted item and including an indication an amount of virtual currency to be provided in exchange for fulfillment of the order, process assignment or allocation of that amount of virtual currency into an escrow account, display, on computing devices, a list of orders and the indication of the amount of virtual currency to be provided in exchange for fulfillment of each order, and enable, using a user interface of the computing devices on which the list of orders is displayed, entry of an indication to fulfill a selected one of the orders and authorize payment of real money for each item in the selected order to a third party. The computer program then directs the amount of virtual currency to be provided in exchange for fulfillment of the selected order is be forwarded upon or after shipping confirmation or delivery of each item in the selected order.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a flow chart showing basic steps of a method in accordance with the invention;

FIG. 2-6 are exemplifying displays that are displayed on computing devices of users of the method shown in FIG. 1; and

FIG. 7 is a schematic showing the main components of a system that implements the method in accordance with the invention.

### DETAILED DESCRIPTION OF THE INVENTION

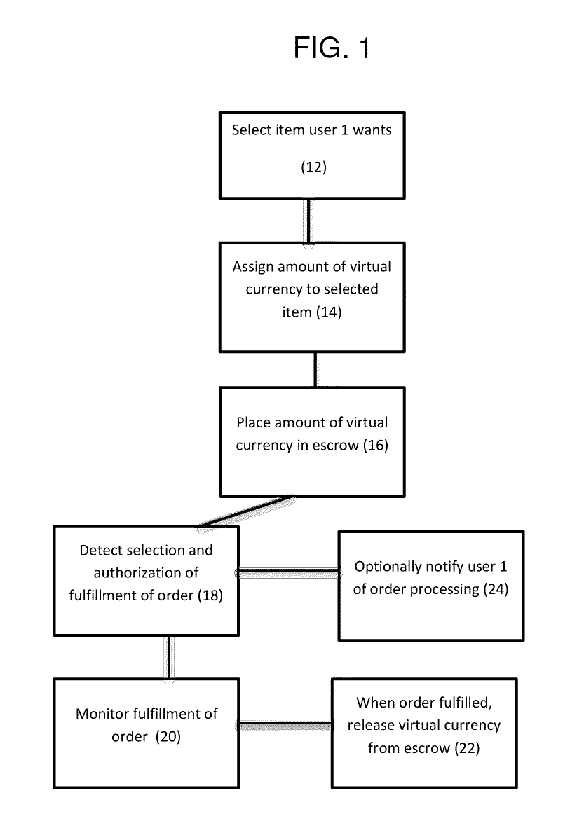

Referring to the accompanying drawings wherein like reference numbers refer to the same or similar elements, FIG. 1 shows a flow chart of a basic method 10 in accordance with the invention for transacting business with virtual currency (VC). In a first step 12, a person accesses a computing device and selects at least one item they want to obtain, usually goods, and in step 14 selects a type of virtual currency they want to use to pay for each item. As used herein, a computing device means any type of electronic apparatus that includes a processor and a display and is capable of interacting with a user. Examples of a computing device includes a desktop computer, a laptop computer, a notebook computer, a tablet, a smartphone, a personal digital assistant (PDA), and a note pad.

The selection of the items in step 12 may be from a pre-populated list of items and/or the user can access the Internet and select items from the Internet to include in their list.

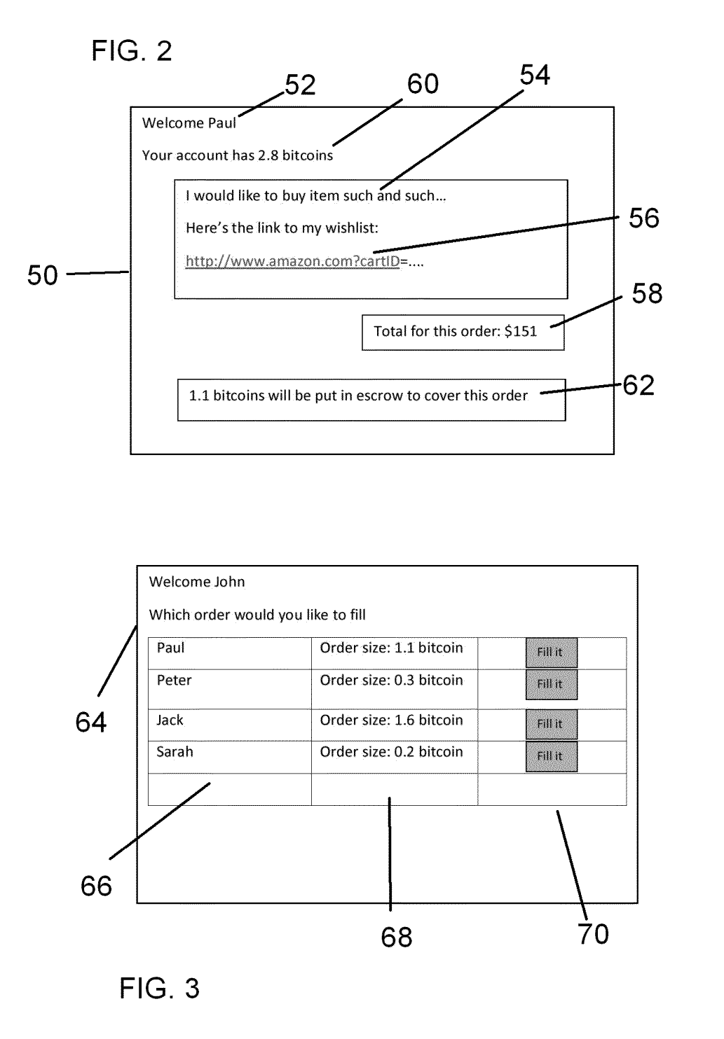

Thus, FIG. 2 shows a typical display 50 at this stage. The user's name 52 is provided on the display 50, along with a list 54 of one or more items selected by the user and a link 56 to the item in the list 54. In the latter situation, it is possible to create a list of sought items using any known website or websites that each enable creation of a wish list of one or more items to be bought on behalf of the item selector (user 1).

A total 58 of real currency for each item in the list 54 and for the total of the items in the list is provided on the display 50.

The display 50 also optionally includes the balance 60 of virtual currency available to the user. This balance 60 is a running total of the amount of virtual currency that is not yet assigned or allocated to items in the user's selection list 54. Once the user indicates their desire for an item by placing it in their selection list 54 (and possibly after an optional, subsequent step of confirming the selection), the corresponding indicated amount of virtual currency is considered assigned. Once assigned, the amount of virtual currency is removed from the available balance 60 and preferably placed into an escrow account that may be managed by the central server operating the method. This ensures that the user has the amount of virtual currency available whenever the item in the list 54 is purchased by someone else on behalf of the user, and that the user thus cannot use the same virtual currency for multiple items.

Accordingly, the display 50 includes an indication 62 of the amount of the virtual currency that will be placed in escrow to cover the cost of each item or the entire list of items (step 16, FIG. 1). Two options are available to provide this indication. First, the user may determine by themselves how much of the virtual currency they are willing to provide to someone who will effect shipping or delivery of one or more items in their list to them. In the illustrated display, the user has indicated that they are willing to provide the purchaser of the item in their list 54, 1.1 bitcoins.

As an alternative, and more likely the preferred options, the current conversion of the real money to the virtual currency may be used to determine how much virtual currency must be placed in escrow. That is, if the value of the item in the list is $200 and the virtual currency is worth $100 at that time, then the user1 will be required to place 2 units of virtual currency in escrow. The exchange rate of the real money to the virtual currency can be retrieved by the central server operating the method and applied formulaically to derive the amount of virtual currency. The amount of virtual currency could also be determined whenever a person accesses the website maintained by the server to select an order to purchase. This is useful since the price of the items in the list may change, and the conversion factor of the virtual currency to the real currency may also change.

The manner in which the virtual currency is placed in escrow and released to the purchaser of the item after or upon shipping confirmation or delivery of the item to the user, and the general escrow account management, may be by any known escrow management techniques known to those skilled in the art. Generally, the virtual currency would not be released until the shipping or the item is confirmed, or in some instances, not until delivery of the item is confirmed, for example, by the delivery service, a third party confirmation service, or the recipient.

An order generated by the user for one or more items may be cancelled by the user at any time prior to selection of the order for purchase. The central server managing the method would therefore include an option for users to manage their orders, adding, changing and deleting orders at their discretion. The order management functions may include those known to persons skilled in the art of Internet commerce, and may, for example, be password-protected.

Using the service, a user of the service having virtual currency can monetize their currency and obtain a physical, tangible object from virtually any merchant, even and especially when that merchant does not accept virtual currency. The user is providing their virtual currency to another, third-party person or entity that in turn, is providing real money to the merchant to effect shipping and subsequent delivery of the object to the user. The merchant may be unaware of the involvement of virtual currency as they are delivering an object at the request of and after payment from the third party.

On the other end, a person seeking to obtain virtual currency can contract with a merchant to deliver a listed object to a user and obtain in exchange, the virtual currency being offered by the user.

FIG. 3 shows a display 64 on a computing device that enables a person to initiate a transaction to obtain virtual currency by authorizing and paying for shipping and subsequent delivery of a listed item to a user. The display 64 in this case includes a list of users (in the first column 66), and list of their order size (second column 68) and a display area indicative of an indication to fill the order (third column 70). Additionally, the display 64 may include an indication of the real money price of the listed object(s).

The person can select the object they want to provide in consideration of its cost to them, as they may be able to obtain the item at a favorable cost relative to the exchange rate of the virtual currency to the real money. Or simply, the person wants to obtain virtual currency (which is often limited in total amount circulating).

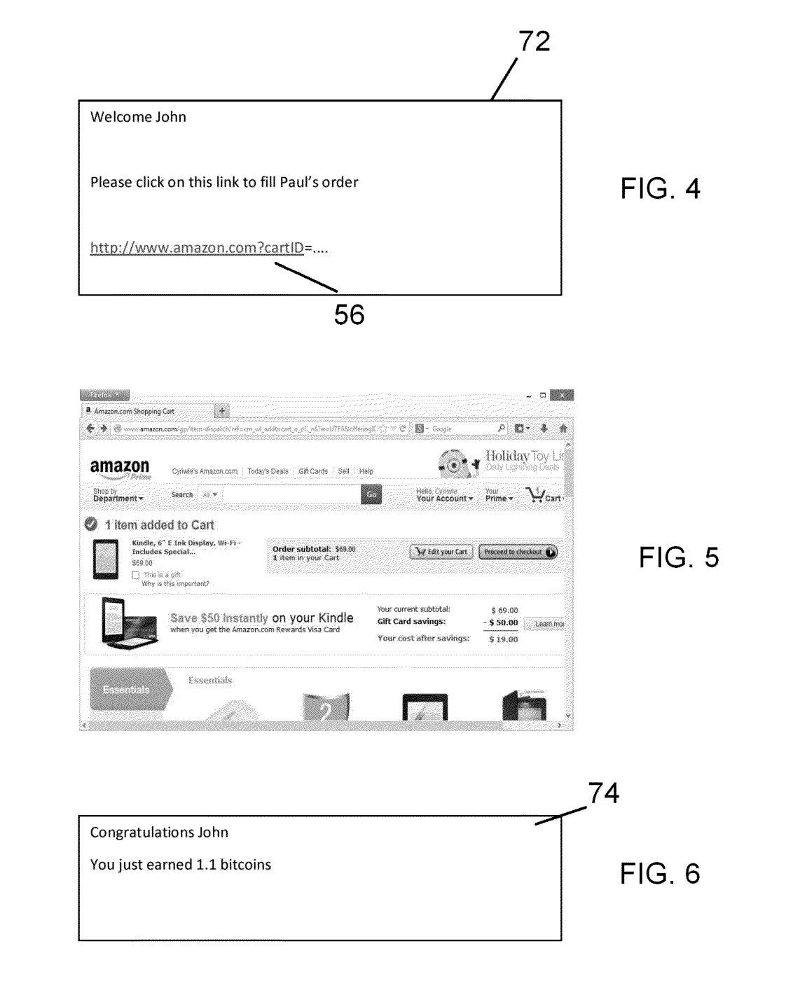

Using a using interface associated with or integral with the computing device, the user (user 2) would select one of the orders (see FIG. 4), be presented with an order fulfillment display 72 and process payment for the item or items in the list, using for example, the link 56. This may involve accessing the vendor's website, and checking out, providing acceptable payment information (e.g., at amazon.com as shown in FIG. 5). Payment of the real money by user 2 for the item or items in the list may be effected in any manner common to Internet commerce, such as using credit cards, debit cards, PAYPAL™ or other payment services, automatic withdrawal from checking or savings accounts, and the like.

After detection of authorization for fulfillment of an order, step 18 in FIG. 1, a central server containing a computer program that manages and coordinates the transaction may be configured to monitor the actual fulfillment of the order, step 20 in FIG. 1, e.g., shipping and delivery, which may include notifying the user1 of the fulfillment of their order and its expected delivery, step 24 in FIG. 1. This will notify them that the virtual currency they assigned or allocated for the item and that has preferably been placed in escrow will be released from escrow after receipt of the item to them.

Each item would be shipped to the user in the normal manner from the vendor and the person would receive, upon or after such shipping confirmation or delivery, the designated amount of virtual currency noted in item 62 on display 50 in FIG. 2, which is represented by step 22 in FIG. 1. A display or notification message 74 shown in FIG. 6 would be provided to the person.

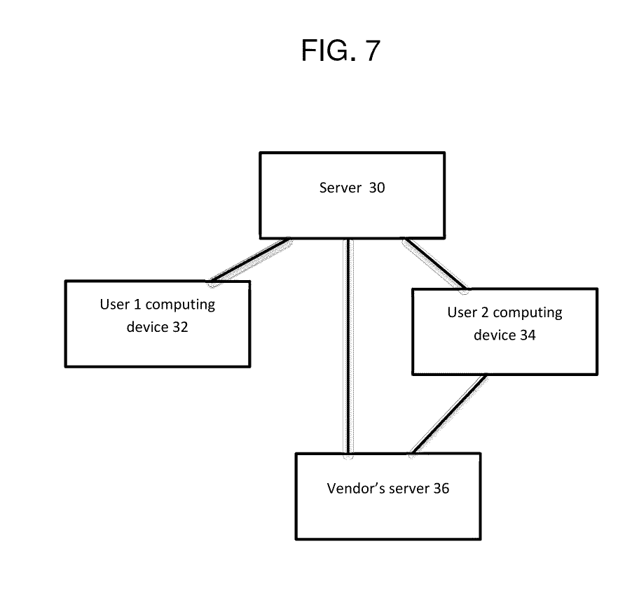

This amount may be placed into an account maintained by a central server 30 on behalf of user2 (see FIG. 7). The server 30 would include electronic componentry (software and/or hardware) that interacts with the computing device 32 (generally user1 being the user that makes a list and wants to pay virtual currency to receive an item), and the computing device 34 (generally user2 that pays traditional, real money to receive virtual currency from user1), memory in which the account information and access protocol information is stored, and merchants or vendor servers 36 to obtain information about items and effect shipping and delivery of items when necessary.

There are several unique features of the invention that differentiate it from prior art Internet-based purchasing transactions. For example, the invention is considerably different from a typical wish list purchase by third parties, e.g., a situation where a child makes a wish list of gifts they want that is disseminated to family members and friends that purchase the items for the child so that the child receives his or her desired items without paying for the items (payment being made by the family members or friends).

The first major difference is that the person that wants the items is offering a virtual currency in exchange for shipping and expected delivery of specific items that are determined by the person. The person is able to exactingly specify what they want and how much virtual currency that are willing to pay for the item. A inform list of correspondence between items and the amount of virtual currency is not used. Rather, each person that wants an item can specify that they will pay an amount of virtual currency of the item. Thus, it is conceivable that for the same items, different people will be willing to pay a different amount of virtual currency. It would behoove the purchaser then to peruse all of the orders and select the order for the same item that will provide them with the highest amount of virtual currency.

Another difference is that the purchaser receives something in returned for their expenditure of real money, namely, an amount of virtual currency that is deposited into their account. The purchaser can therefore shop around themselves for the item, use whatever coupons or merchant discounts that they have acquired or accumulated and them minimize their expenditure for the amount of virtual currency. For example, if a purchaser has a percent off coupon at a specific merchant, they can use that coupon to reduce their purchase amount and increase the ratio of virtual currency they are received to the real monetary value. In this manner, people can be prompted to seek values for the items other people want in order to maximize their own return, i.e., increase the amount of virtual currency they can receive for each unit of real money.

Yet another difference is that each person can both buy and sell their virtual currency by creating an account using the system. As to the sale or transfer of virtual currency, the system is configured to enable creation of an escrow account for virtual currency, allow each user to form an order assigning an amount of virtual currency for an item in their order, and transfer the virtual currency after or upon fulfillment of the order. At the same time, and with respect to the purchase or receipt of virtual currency, the system is configured to allow each user to fulfill an order having an assigned amount of virtual currency using real money, e.g., a credit card, PAYPAL™ and the like, and then receive in their escrow account, the assigned amount of virtual currency after or upon fulfillment of the order.

The invention therefore creates a marketplace which interfaces and involves transactions involving virtual currency and transactions involving real money. This combined use of both virtual currency and real money in a voluntary scheme to satisfy two parties involved in the transaction, i.e., the owner of virtual currency wanting a physical item pays the virtual currency and receives the physical item while a person wanting virtual currency and having real money pays the real money for shipping and expected delivery of the item and receives the virtual currency, is believed to be novel.

The invention is generally described above as enabling a user to make an order for a desired item. It is course possible for the user to include services on their list, e.g., they are willing to pay an amount of virtual currency for a taxi ride. Thus, the invention is not limited to physical, tangible objects.

In the context of this document, computer-readable medium could be any means that can contain, store, communicate, propagate or transmit a program for use by or in connection with the method, system, apparatus or device. The computer-readable medium can be, but is not limited to (not an exhaustive list), electronic, magnetic, optical, electromagnetic, infrared, or semi-conductor propagation medium. The medium can also be (not an exhaustive list) an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The medium can also be paper or other suitable medium upon which a program is printed, as the program can be electronically captured, via for example, optical scanning of the paper or other medium, then compiled, interpreted, or otherwise processed in a suitable manner, if necessary, and then stored in a computer memory. Also, a computer program or data may be transferred to another computer-readable medium by any suitable process such as by scanning the computer-readable medium.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A method for a first person to receive a wanted item purchased by a second person in exchange for virtual currency, comprising:
generating, using a first computing device, an order for at least one wanted item by the first person;
assigning an amount of virtual currency to be provided in exchange for fulfillment of the order for the first person;
displaying on a second computing device, an indication of the assigned amount of virtual currency to be provided in exchange for fulfillment of the order for the first person;
enabling, using a user interface of the second computing device, the second person to view the indication of the amount of virtual currency to be provided in exchange for fulfillment of the order for the first person and indicate a desire to fulfill the order;
enabling, using the second computing device, the second person to fulfill the order and pay real money for each item in the order to a third party; and
forwarding the amount of virtual currency to be provided in exchange for fulfillment of the order to the second person upon or after shipping confirmation of each item in the order to the first person.

2. The method of claim 1, wherein the step of generating, using the first computing device, the order for at least one wanted item by the first person includes incorporating a link to a webpage identifying the at least one wanted item.

3. The method of claim 1, wherein the step of assigning the amount of virtual currency to be provided in exchange for fulfillment of the order for the first person comprises holding the amount of virtual currency to be provided in exchange for fulfillment of the order in escrow.

4. The method of claim 3, further comprising releasing the amount of virtual currency from escrow only after shipping confirmation of each item in the order to the first person.

5. The method of claim 3, further comprising releasing the amount of virtual currency from escrow only after third party confirmation of delivery of each item in the order to the first person.

6. The method of claim 1, further comprising enabling, using a user interface of the first computing device, the first person to indicate the amount of virtual currency to be provided in exchange for fulfillment of the order.

7. The method of claim 1, further comprising determining the amount of virtual currency to be provided in exchange for fulfillment of the order based on an exchange rate of the real money value of the order and the virtual currency.

8. A method for one person to receive a wanted item purchased by another person in exchange for virtual currency, comprising:
generating, using computing devices, a plurality of orders each for at least one wanted item by a person;
assigning an amount of virtual currency to be provided in exchange for fulfillment of each of the orders;
displaying, on computing devices, a list of orders and an indication of the amount of virtual currency to be provided in exchange for fulfillment of each order;
enabling, using a user interface of the computing devices on which the list of orders is displayed, entry of an indication by another person to fulfill a selected one of the orders and authorize payment of real money for each item in the selected order to a third party; and
forwarding the amount of virtual currency to be provided in exchange for fulfillment of the selected order to the another person upon or after shipping confirmation of each item in the selected order.

9. The method of claim 8, wherein the step of generating the orders includes incorporating a link to a webpage identifying the at least one wanted item.

10. The method of claim 8, wherein the step of assigning an amount of virtual currency to be provided in exchange for fulfillment of each of the orders comprises holding the amount of virtual currency to be provided in exchange for fulfillment of each order in escrow.

11. The method of claim 10, further comprising releasing the amount of virtual currency from escrow only after shipping confirmation of each item in the selected order.

12. The method of claim 11, further comprising releasing the amount of virtual currency from escrow only after third party confirmation of delivery of each item in the selected order.

13. The method of claim 8, wherein the step of generating the plurality of orders includes receiving a user-provided indication of the amount of virtual currency to be provided in exchange for fulfillment of the order.

14. The method of claim 8, further comprising determining the amount of virtual currency to be provided in exchange for fulfillment of the order based on an exchange rate of the real money value of the order and the virtual currency.

15. A computer program embodied in non-transitory computer-readable medium, and that when executed by a processor, is configured to:
enable, using a first computing device, generation of an order by an order generator for at least one wanted item and an associated indication of an amount of virtual currency to be provided in exchange for fulfillment of the order; then
receive the amount of virtual currency from the order generator;
direct display on a second computing device of the indication of the amount of virtual currency to be provided in exchange for fulfillment of the order;
enable, using a user interface of the second computing device, entry of an indication of a desire to fulfill the order and authorization of payment of real money for each item in the order to a third party; and
forward the amount of virtual currency to be provided in exchange for fulfillment of the order to the payment authorizer upon or after shipping confirmation of each item in the order.

16. The computer program of claim 15, wherein the computer program is further configured to allow for incorporation of a link to a webpage identifying the at least one wanted item in the order.

17. The computer program of claim 15, wherein the computer program is further configured to maintain an escrow account for each person using the computer program and hold the amount of virtual currency to be provided in exchange for fulfillment of the order in escrow after the indication of the desire to fulfill the order is entered.

18. The computer program of claim 17, wherein the computer program is further configured to release the amount of virtual currency from escrow only after shipping confirmation of each item in the order.

19. The computer program of claim 17, wherein the computer program is further configured to release the amount of virtual currency from escrow only after third party confirmation of delivery of each item in the order.

20. A computer program embodied in non-transitory computer-readable medium, and that when executed by a processor, is configured to:
enable a plurality of orders to be generated, each for at least one wanted item and including an indication an amount of virtual currency to be provided in exchange for fulfillment of the order; then
receive an amount of virtual currency to be provided in exchange for fulfillment of each of the orders;
display, on computing devices, a list of orders and the indication of the amount of virtual currency to be provided in exchange for fulfillment of each order;
enable, using a user interface of the computing devices on which the list of orders is displayed, entry of an indication to fulfill a selected one of the orders and authorize payment of real money for each item in the selected order to a third party; and
forward the amount of virtual currency to be provided in exchange for fulfillment of the selected order upon or after shipping confirmation of each item in the selected order.
